(19) United States
(12) Patent Application Publication
(10) Pub. No.: US 2008/0174263 A1
(43) Pub. Date: Jul. 24, 2008

(54) BATTERY CHARGER FOR DIFFERENT CAPACITY CELLS

(75) Inventors: Anil P. Ghode, Libertyville, IL (US); Martin M. Rayner, Bristol, WI (US)

Correspondence Address: BARNES & THORNBURG LLP, P.O. BOX 2786, CHICAGO, IL, 60690-2786, US

(73) Assignee: SNAP-ON INCORPORATED, Kenosha, WI (US)

(21) Appl. No.: 11/625,733

(22) Filed: Jan. 22, 2007

(51) Int. Cl. H02J 7/00

(52) U.S. Cl. 320/106

(57) ABSTRACT

A battery charger to charge batteries with different capacity cells. A single battery charger is capable of charging different types and different capacity battery cells by detecting battery chemistry. The charger can detect different batteries inserted into the charger and properly charge the different batteries based on optimal charging current for the particular type of cell.

### FIELD OF INVENTION

This invention relates to a battery charger capable of providing a variety of charging currents, and specifically to a battery charger adapted to provide an appropriate charging current based on a detected type of battery.

### BACKGROUND

Battery chargers are used to charge rechargeable batteries by providing current. In order to achieve maximum efficiency when charging a battery, it is beneficial to implement charging techniques geared specifically for a battery cell chemistry. The charging current depends upon the technology and capacity of the battery being charged. Typically, different chargers are used for charging batteries with different cell chemistry. As an example, the chargers and current that should be applied to recharge a 12 volt car battery will be very different to the current for a cell phone battery. The same is true between nickel metal hydride (“NiMH”) and nickel cadmium (“NiCad”) batteries, and even the different capacity among NiMH battery packs (i.e., 2.0 and 2.6 A).

Battery chargers that can work with different types of cells are known. If a single battery charger were used, the charging current was lowered for the lowest NiMH cell rating, such as a 2.0 Amp charge, which would be used with all cell types. A problem that occurs with such a battery charger is that other types of cells are not optimally charged by this relatively low charging current, resulting in longer charge times. Accommodating the exothermic NiMH cell rating produced longer than necessary charge times for the NiCad cells, which could have shorter charge times with a higher charging current. For example, NiMH cells should be charged with maximum 2.0 Amps (for 2.0 Amp-hr cells) or with 2.6 Amps (or lower) for 2.6 Amp-hr rated cells. Conversely, NiCad cells are endothermic and can be charged more quickly with a higher charging current, such as 4.1 Amps. Charging with the appropriate magnitude of electric current optimizes charging and the time to complete charging.

Certain chargers have set durations for charging different batteries (i.e., typically longer for NiMH than NiCad). The output of a timer charger is terminated after a pre-determined time. Timer chargers previously were common for NiCad cells. But these do not adequately accommodate partially drained batteries or inadvertent restarting charging, which can lead to overcharging and destruction of batteries.

Differences between NiMH cells and NiCad cells are well known. NiMH cells often have higher capacity than the same size and weight of NiCad cells. That means that many devices will work longer using NiMH cells. Also, NiMH cells get hotter than NiCad during charge and discharge. This temperature difference is known and measurable.

A disadvantage of NiMH cells is that they usually have higher internal impedance so drawing a lot of current can cause a drop in voltage, which can cause poor performance. NiCad cells have extremely low internal impedance. Some low internal impedance NiMH cells can get almost as low as comparable NiCad cells. Higher internal impedance suggests that fast charging NiMH cell at as high a charge rate as a NiCad cell should be avoided. The process for rapid charging NiCad batteries can overcharge NiMH batteries. Also, NiMH cells often have a shorter life span compared to NiCad cells. Further, NiMH cells tend to lose their charge more quickly than NiCad cells in very hot or cold temperatures.

Typically, a NiMH cell is charged with a constant current until a terminating condition is encountered. A common way to determine when a NiMH cell has become fully charged is to either observe a drop in the voltage or a rise in the temperature. As the cell becomes fully charged, the voltage drops slightly. At the same time, the temperature rises rapidly as less of the charge source energy goes into actually charging the cell and more of the energy turns into heat. Similarly, the internal temperature of NiCad batteries increases when fully recharged. By detecting heat, prior art chargers often determine when a battery is done recharging. For detecting charge termination, a temperature sensor relies on detecting the sudden rise in battery temperature to shut off the charge.

Another method of detecting charge termination is using a “negative delta V” cutoff system, which relies on the electrical characteristic that the NiCad/NiMH battery voltage peaks and drops about 20 mV per cell when fully charged. Battery chargers with this charging feature can detect this voltage peak and determine when a battery has reached its charge capacity. The charger can then stop charging or change to trickle charge mode (which is high enough to keep the battery charged, but low enough to avoid overcharging). Battery chargers are known that provide high current when charging and reduced current to trickle charge.

U.S. Pat. No. 3,105,183 shows a battery charger that is capable of charging batteries having different electrical characteristics. U.S. Pat. No. 5,523,668 discloses a NiCd/NiMH battery charger.

U.S. Pat. No. 5,489,836, which is incorporated herein by reference, discloses a battery charging circuit as a single circuit for charging both NiMH and NiCad batteries. Separate circuits are provided for sensing an end of charge sequence for both battery types. Both circuits operate simultaneously, and one circuit will generate an end of charge signal when a battery corresponding to its type is fully charged. When either circuit signals that a sequence is complete, charging ends. This provides for charging either type of battery without the necessity for determining the type of battery being charged.

U.S. Pat. No. 6,313,605, which is incorporated herein by reference, discloses a method of charging a rechargeable battery that comprises charging the battery with a charging current; sampling conditions of the battery during charging to recognize potential adverse conditions within the battery; interrupting the charging current periodically to create current-free periods and sampling an open circuit voltage of the battery during each current-free period to identify potential overcharge conditions in the battery; lowering the charging current if any adverse conditions are identified and continuing charging with the charging current if adverse charging conditions are not identified; and terminating charging when a predetermined value is recognized. The method of charging nickel-metal hydride and nickel-cadmium batteries is based on switching charging current as soon as temperature related battery open circuit voltage reaches the first predetermined value, tapering current and continuing charging up to terminating point.

U.S. Pat. No. 6,456,035, which is incorporated herein by reference, discloses a battery charger, a method for charging a battery, and a software program for operating the battery charger. The battery charger is capable of charging different types of batteries and capable of operating on alternate sources of AC power or alternate sources of DC power. Also, the battery charging circuit will not operate if one of the power source, the battery, the power switch means and the control means (including the Microcontroller) malfunctions. In addition, in the battery charging circuit, the battery under charge enables the operation of the battery charging circuit.

It is desirable to have smart chargers with sensing and conditioning features controlled by microprocessors or controllers (or other hardware and/or software logic).

### SUMMARY OF THE DISCLOSURE

The disclosure relates to a battery charger that is capable of charging different types and different capacity battery cells. Disclosed is a single charger that can detect different batteries inserted into the charger and properly charge the different batteries based on optimal charging current. The single charger may be used to charge NiCad batteries from 9.6 volts to 18 volts with cell capacities of 1.2, 1.3, 1.9 and 2.4 amp-hours, for example. The charging current is typically approximately 4.1 Amps for NiCad cells. NiCad cells are endothermic and higher charging current can be used. NiMH cells are exothermic and may only be charged with a lower amp charging current. The 2.0 amp-hour cells should be charged with no more than 2.0 amps. The 2.6 amp hour rated cell should be charged with 2.6 amps or lower charging current.

The battery pack may include one or more diodes to identify the type of cell. A controller may sense the type of cell and adjust the charging current accordingly to the optimal charging current.

One of the benefits of this invention is that NiCad batteries can be charged more quickly with higher charging current. The charger also senses the type of NiMH battery and will adjust the optimum charging current. The present invention is different from other devices such that the other devices use different chargers for charging different cell chemistries, rather than different charging currents within a single charger to optimize charging different cells.

### BRIEF DESCRIPTION OF DRAWINGS

The present disclosure will be described hereafter with reference to the attached drawings, which are given as a non-limiting example only, in which:

FIG. 1 is a schematic of an example detection circuit according to an embodiment of the present invention.

FIG. 2 is a schematic of a first battery pack according to an embodiment of the present invention.

FIG. 3 is a schematic of a second battery pack according to an embodiment of the present invention.

FIG. 4 is a schematic of a third battery pack according to an embodiment of the present invention.

FIG. 5 is a schematic of a fourth battery pack according to an embodiment of the present invention.

The exemplification set out herein illustrates embodiments of the disclosure that is not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION OF THE PREFERRED EMBODIMENT

While the present disclosure may be susceptible to embodiment in different forms, there is shown in the drawings, and herein will be described in detail, embodiments with the understanding that the present description is to be considered an exemplification of the principles of the disclosure and is not intended to be exhaustive or to limit the disclosure to the details of construction and the arrangements of components set forth in the following description or illustrated in the drawings.

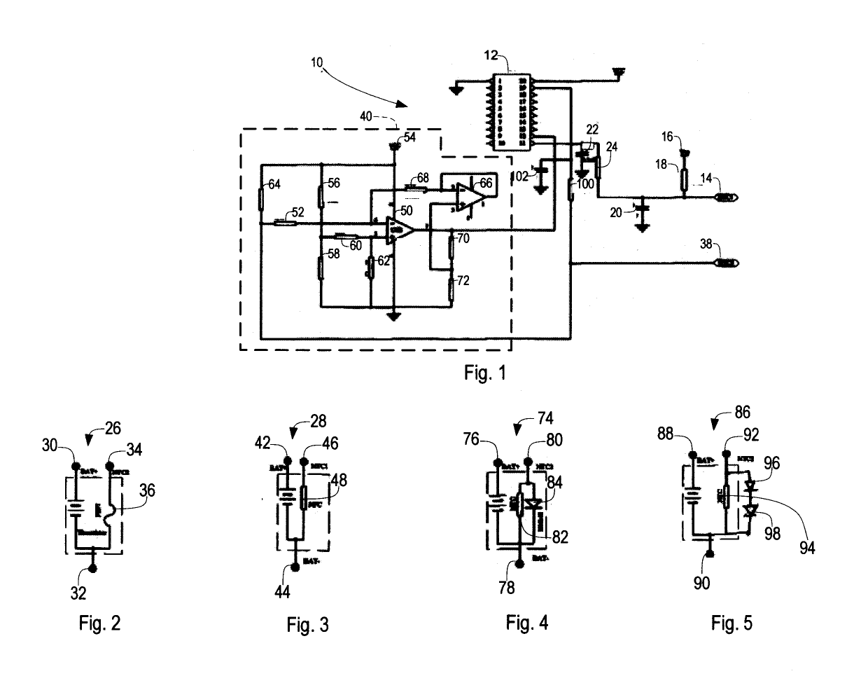

FIG. 1 shows an example detection circuit 10 for use with a battery charger. Typically, the detection circuit 10 is configured to detect a type of battery pack to determine an appropriate charging current for the battery pack. A battery charger that could be controlled using the detection circuit 10 is described in co-pending application Ser. No. ______, concurrently filed herewith, entitled “Battery Charger With Charge Indicator,” the entire disclosure of which is hereby incorporated by reference. FIGS. 2-5 show example battery packs that could be detected by the detection circuit 10. It should be appreciated that other types of battery packs, other than those shown, could also be detected. The terms “circuitry” and “circuit” are broadly intended to include hardware, software and functional equivalents. Herein, the phrase “coupled with” means directly connected to or indirectly connected through one or more intermediate components. Such intermediate components may include both hardware and software based components.

In the embodiment shown, the detection circuit 10 includes a controller 12. By way of example, the controller 12 may be a microcontroller sold under the name S3F9454 by Samsung Electronics. It should be appreciated that one or more other controllers (or microprocessor or other hardware and/or software logic) could be used. Preferably, the controller 12 may detect the type of battery pack based on the voltage of a capacity detection terminal associated with the battery pack, as discussed below. In some cases, for example, the controller 12 may include an analog-to-digital converter (“ADC”) that converts the analog voltage detected on a pin of the controller that is coupled with the capacity detection terminal of the battery pack into a digital value. It should be appreciated that a separate ADC could be used, rather than an onboard ADC.

As discussed below, embodiments are contemplated in which each type of battery pack with a different capacity, chemistry or charging current may be configured to output a unique voltage on the capacity detection terminal. In some embodiments, the controller 12 may have a lookup table stored in memory that correlates detected voltage on capacity detection terminal with appropriate charging currents. For example, if the controller 12 detects 4 volts on the capacity detection terminal, this may correlate to a 4.1 A charging current. By way of another example, if the controller 12 detects 3.3 volts on the capacity detection terminal, this may correlate to a 2.0 A charging current. By way of a further example, if the controller 12 detects 2.6 volts on the capacity detection terminal, this may correlate with a 2.6 A charging current.

In the example shown, the detection circuit 10 includes a first input terminal 14 to which the capacity detection terminal of a battery pack may be coupled. As shown, the first input terminal 14 is coupled with Pin 11 of the controller 12, which provides an ADC function. As discussed above, it should be appreciated that the first input terminal 14 could be coupled with other pins on the controller 12 that provide an ADC function or to a separate ADC that is coupled with the controller 12. In addition, the example shows the first input terminal 14 connected with a power source 16 through a resistor 18, which could be 4.7 k Ohms in some embodiments. In this example, the first input terminal 14 is also coupled with capacitors 20, 22 and resistor 24, which could be 0.1 pF and 22 k Ohms, respectively, in some embodiments.

In this example, the controller 12 may differentiate between types of battery packs based on the voltage level on Pin 11. For example, FIGS. 2 and 3 show a first battery pack 26 and a second battery pack 28. The first battery pack 26 includes a positive terminal 30, a negative terminal 32 and a capacity detection terminal 34. As shown, a thermostat 36 is coupled in series between the capacity detection terminal 38 and the negative terminal 40. The internal temperature of the first battery pack 26 increases upon becoming fully charged, thereby opening the thermostat 36. Although the first battery pack 26 may be coupled with the first input terminal 14, the first battery pack 26 is preferably coupled with a second input terminal 38 so that the controller 12 may detect when the thermostat 36 opens. As discussed below, an optional amplifier circuit 40 may be used to detect when the thermostat 36 opens, which would cause the controller 12 to reduce the charging current. When the first battery pack 26 is coupled with a battery charger, in the embodiment shown, the positive terminal 30 will be coupled with the positive output terminal of the charger, the negative terminal 32 will be coupled with the negative output terminal of the charger, and the capacity detection terminal 34 may be coupled with Pin 11 of the controller 12.

In the example shown, the second battery pack 28 includes a positive terminal 42, a negative terminal 44 and a capacity detection terminal 46. When the second battery pack 28 is coupled with a battery charger, in the embodiment shown, the positive terminal 42 will be coupled with the positive output terminal of the charger, the negative terminal 44 will be coupled with the negative output terminal of the charger, and the capacity detection terminal 46 may be coupled with Pin 11 of the controller 12. As shown, a temperature sensor 48, such as a negative temperature coefficient (“NTC”) resistor, may be coupled between the capacity detection terminal 46 and the negative terminal 44. While the NTC resistor may have an initially high resistance, the resistance decreases quickly to substantially zero resistance as the second battery pack 28 is charged.

In the example shown, the first battery pack 26 and the second battery pack 28 are configured to receive the same charging current because each will have the same voltage on the first input terminal 14, at least until the thermostat 36 opens. Consider an example in which the first battery pack 26 is a 9.6 volt NiCad battery pack while the second battery pack 28 is a 12 volt NiCad battery pack. In this example, both the first battery pack 26 and the second battery pack 28 may have a charging current of 4.1 A. Accordingly, both battery packs 26 and 28 are configured to be detected by the controller 12 as having a 4.1 Amp charging current. Since the connection between the capacity detection terminals 34, 46 and negative terminals 32, 44 will be approximately short circuits (until the thermostat 36 opens), the controller 12 may associate a zero voltage drop at the capacity detection terminals 34, 46 as corresponding to a 4.1 Amp charging current. Accordingly, the controller 12 may adjust the charging current of a charger to be 4.1 Amp with such a configuration.

Preferably, the first battery pack 26, FIG. 2, is coupled with the second input terminal 38, which is coupled with the optional amplifier circuit 40. As shown, the amplifier circuit 40 is coupled with Pin 12 of the controller 12. The output of the amplifier circuit 40 allows the controller 12 to detect when the thermostat 36 opens due to an increased internal temperature of the first battery pack 26, which indicates that the first battery pack 26 is fully charged. In other words, the amplifier circuit 40 continues to provide a voltage to the controller 12 even when the thermostat 36 opens (which would cause a floating input to the controller 12). In this example, the second input terminal 38 is coupled to the inverted input of a first operational amplifier 50 through a resistor 52, which may be 100 k Ohms in some embodiments. A power source 54 is coupled with the non-inverted input of the first operational amplifier 50 through resistors 56, 58, 60 and 62, which may be 10 k Ohms, 2.7 k Ohms, 100 k Ohms and 100 k Ohms, respectively, in some embodiments. A resistor 64 may be provided between the power source 54 and the resistor 52. The second input terminal 38 is also coupled with the inverted input of a second operational amplifier 66 through a resistor 68, which may be 200 k Ohms in some embodiments. The output of the second operational amplifier 66 may be provided as feedback to the inverted input of the second operational amplifier 66. The output of the first operational amplifier 50 is coupled with a resistor 70, which may be 2 k Ohms in some embodiments. The resistor 70 is in series with a resistor 72, which may be 8.06 k Ohms in some embodiments. The node between resistors 70, 72 is coupled with the non-inverted input of the second operational amplifier 66. Although the amplifier circuit 40 is shown for purposes of example, other circuits that may indicate to the controller 12 the opening of the thermostat 36 could be used instead of the amplifier circuit 40.

FIG. 4 shows a third battery pack 74, such as a 14.4 Volt NiMH battery pack. As shown, the third battery pack 74 includes a positive terminal 76, a negative terminal 78 and a capacity detection terminal 80. The third battery pack 74 is configured to have a voltage drop across the capacity detection terminal 80 and the negative terminal 78, which differentiates the third battery pack 74 from the first battery pack 26 (FIG. 2) and the second battery pack 28 (FIG. 3) for the controller 12. In the example shown, the voltage detected on the battery capacity terminal 80 will be the voltage across a NTC resistor 82 and a diode 84. As the NTC resistor 82 warms up when the third battery pack 74 is coupled with a battery charger, the resistance of the NTC resistor 82 will drop, such that the voltage across the NTC resistor 82 and diode 84 will be approximately equal to the forward voltage drop of the diode 84. If the diode 84 is a silicon diode, for example, the voltage drop will be approximately 0.7 volts. The use of other diodes, such as a Schottky diode or a Germanium diode, could provide a different voltage level. Accordingly, the controller 12 could detect the first battery pack 26 based on an approximately zero voltage drop between the battery capacity terminal 34 and negative terminal 32, at plug in, while the third battery pack 74 could be detected if the voltage drop between the battery capacity terminal 80 and the negative terminal 78 is approximately 0.7 volts (in the case of a silicon diode). With this voltage information, the controller 12 may determine suitable charging current using a lookup table or the like. If the third battery pack 74 were a 14.4 Volt NiMH battery pack, for example, the controller 12 may instruct the charger to use a 2.0 Amp charging current.

Although the third battery pack 74 may be coupled with the first input terminal 14, which would allow the controller 12 to detect the voltage on Pin 11, the third battery pack 74 is preferably coupled with the second input terminal 38. Although the third battery pack 74 could be coupled with the amplifier circuit 40 in some embodiments, the amplifier circuit 40 would not be needed in this example because the third battery pack 74 will not become an open circuit like the first battery pack 26; instead, the controller 12 could detect the voltage on the second input terminal 38 on Pin 19 in this example, similarly as described with respect to Pin 11.

FIG. 5 shows a fourth battery pack 86, such as a 18.0 Volt NiMH battery pack. As shown, the fourth battery pack 86 includes a positive terminal 88, a negative terminal 90 and a capacity detection terminal 92. The fourth battery pack 86 is similar to the third battery pack 74, except that there is an increased voltage drop between the capacity detection terminal 92 and the negative terminal 90, which differentiates the fourth battery pack 86 from the other battery packs, 26, 28 and 74. In the example shown, fourth battery pack 86 includes a NTC resistor 94 in parallel with a pair of diodes 96, 98 that are in series. As the NTC resistor 94 warms up when the fourth battery pack 86 is coupled with a battery charger, the resistance of the NTC resistor 94 will drop, such that the voltage across the NTC resistor 94 and diodes 96, 98 will be approximately equal to the forward voltage drop of the diodes 96, 98. With this voltage information, the controller 12 may determine an appropriate charging current using a lookup table or the like. If the fourth battery pack 86 were an 18 Volt NiMH battery pack, for example, the controller 12 may instruct the charger to use a 2.6 Amp charging current. Although the fourth battery pack 86 may be coupled with the first input terminal 14, which would allow the controller 12 to detect the voltage on Pin 11, the fourth battery pack 86 is preferably coupled with the second input terminal 38, which is connected to Pin 19 of the controller 12 through a resistor 100 and a capacitor 102. Although the fourth battery pack 86 could be coupled with the amplifier circuit 40 in some embodiments, the amplifier circuit 40 would not be needed in this example because the fourth battery pack 86 will not become an open circuit like the first battery pack 26; instead, the controller 12 could detect the voltage on the Pin 19 in the embodiment shown.

Consider the following example, in which the first battery pack 26 is a 9.6 Volt NiCad battery pack with a 4.1 Amp charging current, the second battery pack 28 is a 12 Volt NiCad battery pack with a 4.1 Amp charging current, the third battery pack 74 is a 14.4 Volt NiMH battery pack with a 2.0 Amp charging current and the fourth battery pack 86 is a 18 Volt NiMH battery pack with a 2.6 Amp charging current. The user may couple the positive and negative terminals 30, 32 of the first battery pack 26 with respective positive and negative terminals of a charger, while the battery capacity terminal 34 may be coupled with the first input terminal 14. In this example, the controller 12 will detect the voltage on the battery capacity terminal 34 on Pin 11 (which will be zero volts in this example) and look up the suitable charging current from a table in memory, which in this example is 4.1 Amps. Accordingly, the controller 12 will instruct the charger to supply 4.1 Amps of charging current. When the first battery pack 26 is fully charged, the thermostat 36 will open due to increased internal temperature within the first battery pack 26. The controller 12 can detect that the thermostat 36 opened due to the input from the amplifier circuit 40 on Pin 12. Accordingly, the controller 12 will instruct the charger to stop charging the first battery pack 26 or supply a trickle charge. If the user coupled the second battery pack 28 to a charger, such that the battery capacity terminal 46 is coupled with the second input terminal 38, the controller 12 will detect the voltage on the battery capacity terminal 46 on Pin 19 (which will be zero volts in this example) and look up the suitable charging current from a table in memory, which in this example is 4.1 Amps. Likewise, the controller 12 may differentiate between the third battery pack 74 and the fourth battery pack 86 due to the differing number of diodes and instruct the charger to provide a charging current of 2.0 and 2.6 Amps, respectively. Accordingly, in this example, the controller 12 is configured to instruct the charger to provide 4.1 Amps, 2.0 Amps, and 2.6 when a voltage of 0, less than 1 (assuming a silicon diode), and greater than 1 (assuming two silicon diodes) is detected, respectively.

While this disclosure has been described as having an exemplary embodiment, this application is intended to cover any variations, uses, or adaptations using its general principles. It is envisioned that those skilled in the art may devise various modifications and equivalents without departing from the spirit and scope of the disclosure as recited in the following claims. Further, this application is intended to cover such departures from the present disclosure as come within the known or customary practice within the art to which it pertains.

1. A battery charger to charge batteries with different capacity cells by using different charging currents, the charger comprising:
a battery charging circuit;
means for identifying an appropriate charging current of a battery pack to be charged; and
means for adjusting a charging current supplied by the battery charging circuit based on the appropriate charging current identified.

2. The battery charger of claim 1, wherein the means for adjusting charging current is configured to adjust the charging current of the battery charging circuit from the group consisting of 2.0, 2.6 and 4.1 Amps.

3. The battery charger of claim 1, wherein the means for identifying an appropriate charging current identifies an appropriate charging current by detecting a voltage on a battery capacity terminal of the battery pack.

4. The battery charger of claim 1, wherein the means for identifying an appropriate charging current includes circuitry that detects an appropriate charging current of a battery pack.

5. The battery charger of claim 1, wherein the means for identifying an appropriate charging current includes circuitry that is configured to differentiate between battery packs with different cells chemistries.

6. The battery charger of claim 5, wherein the circuitry is configured to differentiate between a nickel cadmium cell and a nickel metal hydride cell.

7. The battery charger of claim 1, wherein the circuit includes a controller adapted to detect a cell chemistry before adjusting the charging current.

8. The battery charger of claim 1, wherein the means for identifying an appropriate charging current includes an amplifier circuit.

9. A detection circuit for use in controlling a charging current of a battery charger, the detection circuit comprising:
an input terminal adapted to be coupled with a terminal on a battery;
a controller configured to detect a voltage on the input terminal;
a memory operatively coupled with the controller and adapted to store correlation data indicative of an appropriate charging current corresponding with the voltage detected by the controller;
wherein the controller includes a program of instructions comprising:
instructions to detect the voltage on the input terminal; and
instructions to adjust a charging current of the battery charger responsive to the voltage detected on the input terminal.

10. The detection circuit of claim 9, wherein controller is configured to adjust the charging current to 4.1 Amps if zero volts are detected on the input terminal.

11. The detection circuit of claim 10, wherein the controller is configured to adjust the charging current to 2.0 Amps if less than 1 volt, but greater than 0 Volts are detected on the input terminal.

12. The detection circuit of claim 11, wherein the controller is configured to adjust the charging current to 2.6 Amps if greater than 1 volts are detected on the input terminal.

13. The detection circuit of claim 9, further comprising an amplifier circuit coupled between the input terminal and the controller.

14. The detection circuit of claim 13, wherein the controller is configured to adjust the charging current to substantially 0 Amps responsive to an output of the amplifier circuit.

15. A battery pack comprising:
a housing;
a battery portion disposed within the housing;
a positive terminal coupled with the battery portion;
a negative terminal coupled with the battery portion;
a battery capacity terminal coupled with the negative terminal; and
a NTC resistor coupled between the battery capacity terminal and the negative terminal.

16. The battery pack of claim 15, further comprising a first diode coupled in parallel with the NTC resistor.

17. The battery pack of claim 16, further comprising a second diode coupled in series with the first diode, but in parallel with the NTC resistor.

18. The battery pack of claim 15, wherein the battery portion includes at least one nickel-cadmium cell.

19. The battery pack of claim 16, wherein the battery portion includes at least one nickel metal hydride cell.

20. The battery pack of claim 15, wherein a charging current of the battery portion is selected from the group consisting of 4.1, 2.0 and 2.6 Amps.
